(19) United States
(12) Patent Application Publication
(10) Pub. No.: US 2011/0010930 A1
(43) Pub. Date: Jan. 20, 2011

(54) APPARATUS FOR INSERTING SEAL INTO SLEWING BEARING

(75) Inventor: Don Yoo CHOI, Seoul (KR)

Correspondence Address: HOSOON LEE, 9600 SW OAK ST. SUITE 525, TIGARD, OR, 97223, US

(73) Assignee: SHILLA CORPORATION CO., LTD., Chungcheongnam-do (KR)

(21) Appl. No.: 12/835,622

(22) Filed: Jul. 13, 2010

(30) Foreign Application Priority Data
Jul. 17, 2009 (KR) 10-2009-0065447

(51) Int. Cl. B25B 27/02

(52) U.S. Cl. 29/724

(57) ABSTRACT

Disclosed is an apparatus for inserting a seal into a slewing bearing including a main body and a pressing unit. The main body is fixed to any one of a first ring and a second ring of the slewing bearing. The pressing unit projects from the main body toward a sealing installation position of the other one of the first ring and the second ring. The pressing unit is installed by pressing a seal supplied from the exterior to the sealing installation position toward the sealing installation position as the first ring and the second ring are relatively rotated. Therefore, the seal is installed at the sealing installation position between the first ring and the second ring of the slewing bearing so that the seal of the slewing bearing can be easily exchanged and an exchange operation time of the seal can be reduced.

### CROSS REFERENCE TO RELATED APPLICATIONS

This application claims priority from Korean Patent Application No. 10-2009-0065447, filed on Jul. 17, 2009, the disclosure of which is incorporated herein in its entirety by reference.

### BACKGROUND OF THE INVENTION

1. Field of the Invention

The present invention relates to an apparatus for inserting a seal into a slewing bearing, and more particularly, to an apparatus for inserting a seal into a slewing bearing capable of installing the seal at a sealing installation position of a first ring or a second ring of the slewing bearing.

2. Description of the Related Art

A slewing bearing is referred to as a slewing ring bearing or a 4-point contact ball bearing, which is used in a rotation part of large equipment.

Such slewing bearings are variously used in ships and heavy industries, for example, used for slewing motion between a fixed part and a slewing part of heavy equipment for construction such as an excavator, a crane, etc., and large equipment such as photovoltaic equipment, a wind turbine, a large antenna, etc. The slewing bearings are used under severe conditions upon slewing motion in which a large vertical load is supported, a thrust load, a radial load and an offset load are supported, and the large equipment is slewed in an inclined state, since the slewing bearings are used for slewing motion. Therefore, the slewing bearing for large equipment requires supplementation of lubrication oil such as grease, etc., or repairs and exchanges of parts due to frequent friction of or damage to the parts.

FIG. 1 is a plan view of a conventional slewing bearing, and FIG. 2 is a cross-sectional view taken along line C-C of FIG. 1. As shown in FIGS. 1 and 2, the slewing bearing includes a first ring 110 formed at the exterior thereof, and a second ring 120 formed at the interior thereof. In addition, seals 130 are installed on and under a sealing portion between the first ring 110 and the second ring 120.

The seal 130 installed on the sealing portion is press-fitted into an insertion groove formed along an inner circumference of the first ring 110 at its one end, and in contact with the second ring 120 at the other end. The seal 130 installed under the sealing portion is press-fitted into an insertion groove formed along an outer circumference of the second ring 120 at its one end, and in contact with the first ring 110 at the other end.

Therefore, the seals 130 seal a space between the first ring 110 and the second ring 120 to protect bearing balls installed therebetween and to prevent leakage of lubrication oil.

In the slewing bearing, parts between the first ring 110 and the second ring 120 of the slewing bearing can be exchanged or repaired after separation of the fixed part and the slewing part of the large equipment, in which the slewing bearing is installed, upon repairs or exchange of the parts. Therefore, the repair or exchange operation of the slewing bearing becomes complicate and difficult, and also takes a long time.

In particular, even when the seal 130 installed at the sealing installation position of the first ring 110 or the second ring 120 of the slewing bearing is worn so as to be simply exchanged with a new one, parts interfered with due to interference, etc., between connected parts must be separated, and the fixed part and the slewing part of the large equipment must also be separated.

In addition, since the seal 130 is manually installed at the sealing installation position of the first ring 110 or the second ring 120 of the slewing bearing upon exchange of the seal, the installation position of the seal 130 is not constant and perfect sealing cannot be performed, and the lubrication oil such as grease, etc., may leak or internal parts may be damaged.

### SUMMARY OF THE INVENTION

Accordingly, it is an object of the present invention for solving the above problems to provide an apparatus for inserting a seal into a slewing bearing capable of easily exchanging the seal of the slewing bearing with a new one and reducing an exchange operation time, reducing a repair operation time by removing necessity of separating a first ring and a second ring of the slewing bearing and separating a fixed part and a slewing part coupled thereto, being applied to various sizes of slewing bearings or seals, and easily guiding and installing the seal to a sealing installation position.

In order to accomplish the objects, the present invention provides an apparatus for inserting a seal into a slewing bearing including: a main body fixed to any one of a first ring and a second ring of the slewing bearing; and a pressing unit projecting from the main body toward a sealing installation position provided at the other one of the first ring and the second ring, and installed by pressing a seal supplied from the exterior to the sealing installation position toward the sealing installation position as the first ring and the second ring are relatively rotated to each other. Therefore, the seal can be easily installed at the sealing installation position between the first ring and the second ring of the slewing bearing and the sealing is securely accomplished.

In the present invention, the main body may have a fixing groove to be fixed to any one of the first ring and the second ring by a fastener. Therefore, the main body is easily fixed to the first ring or the second ring of the slewing bearing.

In the present invention, the pressing unit may include a pressing roller for pressing a seal to the sealing installation position. Therefore, friction between the pressing unit and the seal during pressing of the seal is reduced to allow easy installation of the seal.

In addition, the main body may have a sliding groove in which the pressing unit slides to approach or be spaced apart from the sealing installation position, and the present invention may further include an adjustment unit for adjusting a sliding position of the pressing unit in the sliding groove. Therefore, the present invention can be applied to various sizes of slewing bearings and seals.

In the present invention, the adjustment unit may include an adjuster threadedly engaged with the pressing unit to slide the pressing unit through a rotation operation. Therefore, a position of the pressing unit can be easily adjusted by the adjuster.

In the present invention, the main body may include a measurement means for measuring a sliding position of the pressing unit in the sliding groove of the pressing unit. Therefore, an installation position of the seal is uniformly maintained at the sealing installation position of the slewing bearing.

In addition, the apparatus of the present invention may further include a guide unit disposed on the main body and adjacent to the pressing unit to guide the seal supplied from the exterior toward the pressing unit. Therefore, the seal is easily guided to the pressing unit.

In the present invention, the guide unit may include a guide roller. Therefore, friction is between the guide unit and the seal during guidance of the seal is reduced to allow easy guidance of the seal.

In the present invention, the guide unit may be position-adjustably fixed on the main body. Therefore, a position of the guide unit can be adjusted on the main body.

In the present invention, the guide unit may have a slotted hole for adjusting a position thereof on the main body, and may be fixed on the main body through a fastening means inserted into the slotted hole. Therefore, a position of the guide unit can be readily moved along the slotted hole.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the aspects of the invention.

FIG. 1 is a plan view showing a conventional slewing bearing;

FIG. 2 is a cross-sectional view taken along line C-C of FIG. 1;

FIG. 3 is a perspective view of an apparatus for inserting a seal into a slewing bearing in accordance with an exemplary embodiment of the present invention;

FIG. 4 is an exploded perspective view of the apparatus for inserting a seal into a slewing bearing in accordance with an exemplary embodiment of the present invention;

FIG. 5 is a plan view of the apparatus for inserting a seal into a slewing bearing in accordance with an exemplary embodiment of the present invention;

FIG. 6 is a cross-sectional view of the apparatus for inserting a seal into a slewing bearing in accordance with an exemplary embodiment of the present invention; and

FIG. 7 is a schematic view showing an operation state of the apparatus for inserting a seal into a slewing bearing in accordance with an exemplary embodiment of the present invention.

### DETAILED DESCRIPTION OF EXEMPLARY EMBODIMENTS

The invention is described more fully hereinafter with reference to the accompanying drawings, in which exemplary embodiments of the invention are shown.

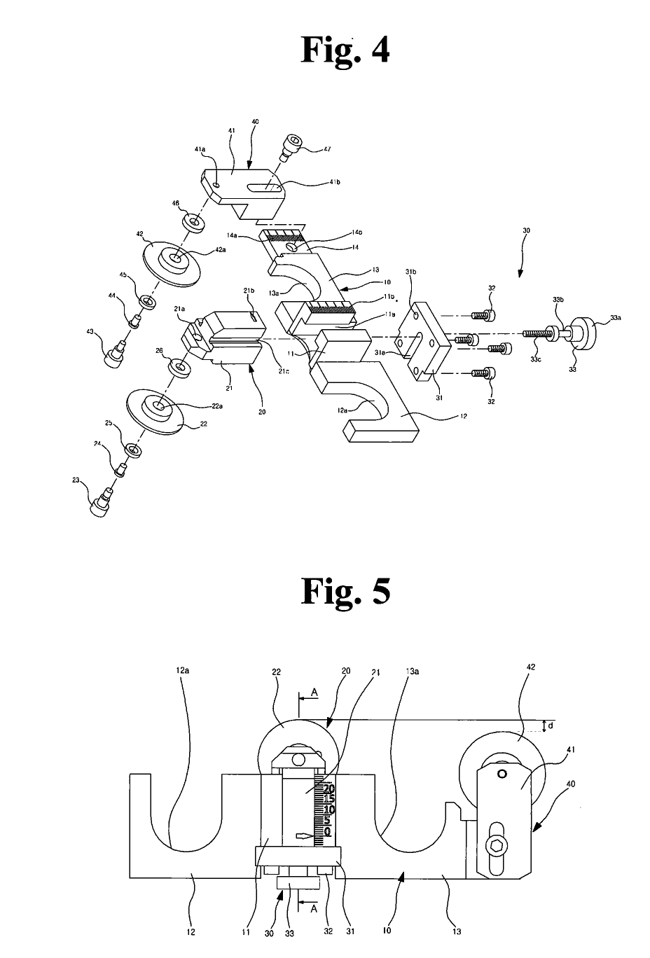

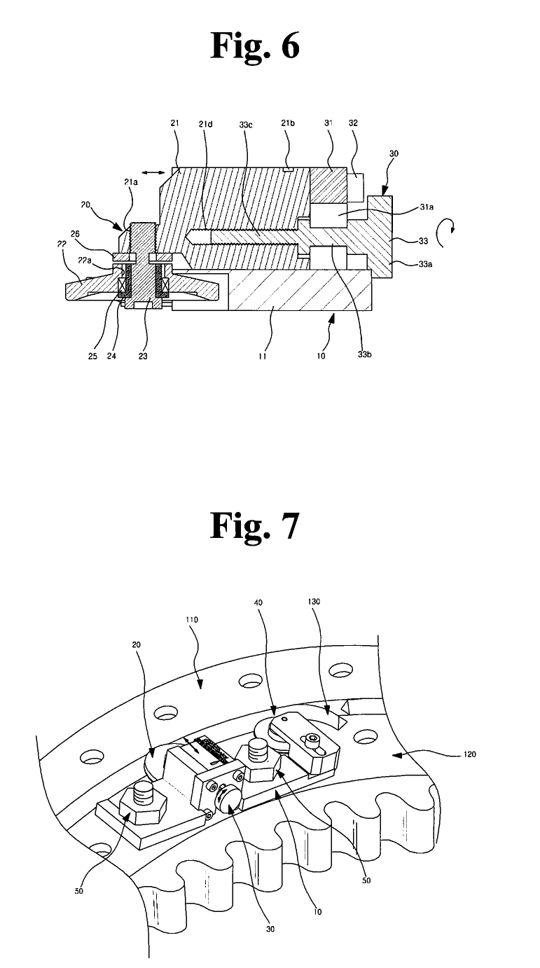

FIG. 3 is a perspective view of an apparatus for inserting a seal into a slewing bearing in accordance with an exemplary embodiment of the present invention, FIG. 4 is an exploded perspective view of the apparatus for inserting a seal into a slewing bearing in accordance with an exemplary embodiment of the present invention, FIG. 5 is a plan view of the apparatus for inserting a seal into a slewing bearing in accordance with an exemplary embodiment of the present invention, FIG. 6 is a cross-sectional view of the apparatus for inserting a seal into a slewing bearing in accordance with an exemplary embodiment of the present invention, and FIG. 7 is a schematic view showing an operation state of the apparatus for inserting a seal into a slewing bearing in accordance with an exemplary embodiment of the present invention.

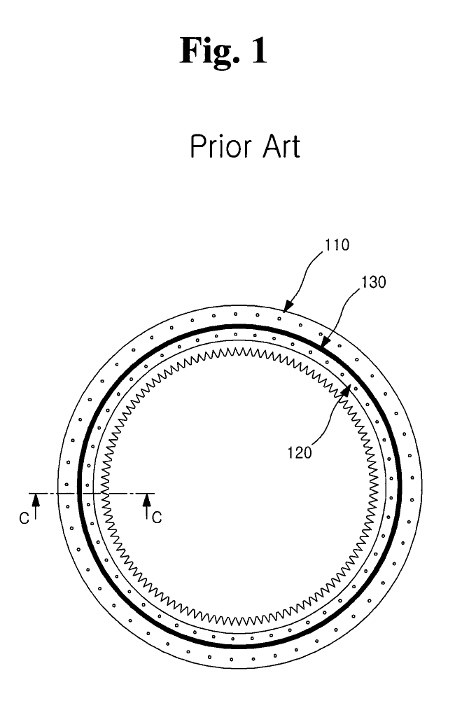

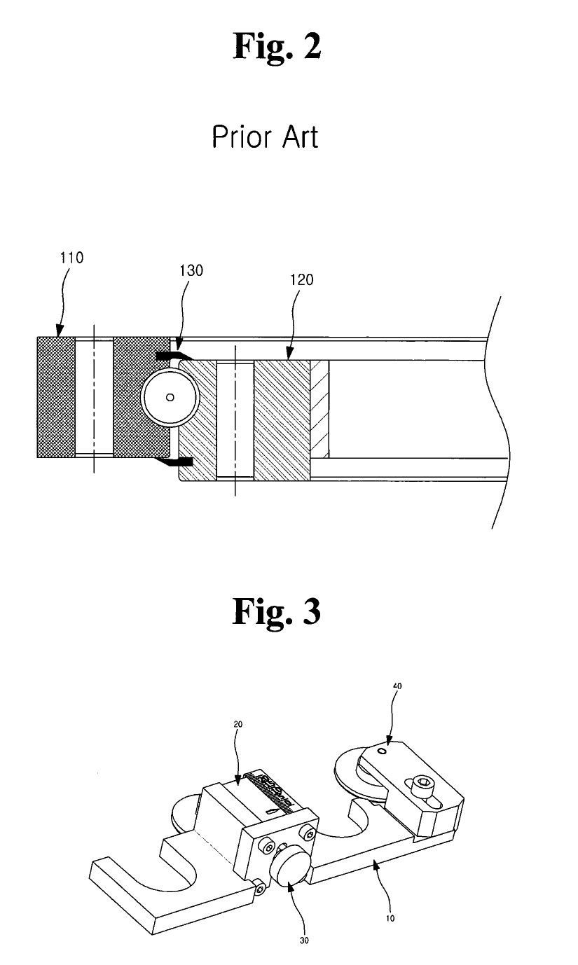

Like reference numerals of the slewing bearing shown in FIGS. 1 and 2 denote like elements of a slewing bearing of the present invention, and detailed description thereof will be omitted.

As shown in FIGS. 3 and 4, the apparatus for inserting a seal into a slewing bearing of this embodiment includes a main body 10, a pressing unit 20, an adjustment unit 30, and a guide unit 40, wherein a seal 130 is installed in a sealing space between a first ring 110 and a second ring 120.

The main body 10 is fixed to the second ring 120 formed in the slewing bearing, and includes a main block 11, a first fixing block 12, a second fixing block 13, and a guide block 14.

The main block 11 is formed at a center of the main body 10, and has a sliding groove 11a, an upper surface of which is partially open. The sliding groove 11a is formed in a is longitudinal direction so that the main block 11 moves forward or backward to/from a sealing portion of the slewing bearing.

In addition, a ruler 11b having gradations is installed at one side of an upper surface of the main block 11 to measure a moving distance of the pressing unit 20, which moves along the sliding groove 11a.

The first fixing block 12 and the second fixing block 13 are formed at both sides of the main block 11, and have a first fixing groove 12a and a second fixing groove 13a, which are fixed to the second ring 120 by fasteners, respectively.

The guide block 14 is formed at one side end of the main body 10 to couple the guide unit 40 thereto. A ruler 14a is formed at one side of an upper surface of the guide block 14 to represent a moving distance of the guide unit 40, and a coupling hole 14b is formed at a center of the upper surface to couple the guide unit 40 thereto.

The pressing unit 20 is slidably coupled to the sliding groove 11 a of the main body 10 to project from the main body 10 toward the sealing installation position of the slewing bearing, and includes a pressing block 21, a pressing roller 22, a fixing bolt 23, a bushing 24, a bearing 25, and a rotation ring 26.

The pressing block 21 is slidably inserted into the sliding groove 11a of the main body 10, and has a coupling hole 21a formed at its front end. An indicator 21b is formed at the rear upper surface of the pressing block 21 as an indicating means corresponding to the ruler 11b of the main block 11 to indicate gradations of the ruler 11b. Herein, the term “front” means a direction that the pressing block 21 is moved toward the seal 130 and the term “rear” means a reverse direction thereof, that is, the pressing block 21 is moved away from the seal 130 along the arrow shown in FIG. 7. A pair of grooves 21c are formed at both side surfaces of the pressing block 21 to reduce friction with the main body 10 upon sliding of the pressing unit 20.

The pressing roller 22 having a through-hole 22a formed at its center is coupled to be rotated about the fixing bolt 23 as a rotary shaft coupled to a coupling hole 21a formed at a front end of the pressing block 21.

The fixing bolt 23, a coupling member for rotatably coupling the pressing roller 22 to the pressing block 21, is inserted into the through-hole 22a of the pressing roller 22 to be coupled to the coupling hole 21a of the pressing block 21.

The bushing 24 is inserted into the through-hole 22a of the pressing roller 22 to maintain smooth rotation of the pressing roller 22. The bearing 25 is inserted between an inner circumference of the pressing roller 22 and an outer circumference of the bushing 24 to reduce friction between the pressing roller 22 and the bushing 24, allowing smooth rotation of the pressing roller 22. The rotation ring 26 is inserted into a groove formed at an outer circumference of the fixing bolt 23 and positioned between the pressing block 21 and the pressing roller 22 to reduce friction between the pressing block 21 and the pressing roller 22.

Therefore, the second ring 120 of the slewing bearing is fixed and the first ring 110 is rotated about the second ring 120 so that the pressing unit 20 of this embodiment presses the seal 130 supplied from the exterior to the sealing installation position of the first ring 110 toward the sealing installation position, i.e., the insertion groove to install the seal 130.

Of course, in the apparatus for inserting a seal into a slewing bearing, the pressing unit 20 may be installed at the main body 10 to press the seal 130 toward the sealing installation position of the first ring 110 of the slewing bearing. In addition, the apparatus may further include at least one of the adjustment unit 30 and/or the guide unit 40 to adjust a pressing position of the seal 130 and/or guide the seal 130 to the pressing unit 20.

The adjustment unit 30 is fixed to a rear end of the sliding groove 11a of the main body 10, and threadedly engaged with a rear end of the pressing unit 20 to slide the pressing unit 20 to a predetermined distance. The adjustment unit 30 includes a fixing plate 31, a plurality of fastening means 32, and an adjuster 33.

The fixing plate 31 is fixed to a rear surface of the main body 10 and press-fitted between the first fixing block 12 and the second fixing block 13. Coupling holes 31b are formed at four corners of the fixing plate 31 to fix it to the rear surface of the main block 11, respectively, and a slotted groove 31a is formed upward from a center of a lower end thereof.

The plurality of fastening means 32, fasteners such as bolts or screws coupled to the coupling holes 31b of the fixing plate 31, are fastened to the main block 11 through the coupling holes 31b to fix the fixing plate 31 to the rear surface of the main block 11.

The adjuster 33 is coupled to an adjustment hole 21d formed inside of the pressing unit 20 to slide in the sliding groove 11a to adjust a position of the pressing unit 20. The adjustment hole 21d is formed inward from the rear surface of the pressing unit 20. The adjuster 33 includes a knob 33a, an insertion part 33b and a threaded part 33c.

The knob 33a is formed at a rear end of the adjuster 33 to provide a drive force to slide the pressing unit 20 forward and backward by an operation of a user. The insertion part 33b is press-fitted into the slotted groove 31a of the fixing plate 31 and has thresholds at both sides to be rotated only in a state in which the adjuster 33 is press-fitted into the slotted groove 31a of the fixing plate 31. The threaded part 33c formed at a front end of the adjuster 33 is threadedly engaged with adjustment hole 21d of the pressing block 21 to slide the pressing unit 20 to approach or be spaced from the sealing installation position of the slewing bearing by an operation of the knob 33a.

The guide unit 40 is installed at a position adjacent to the pressing unit 20, i.e., installed at one side of the pressing unit 20 to guide the seal 130 to the pressing unit 20. The guide unit 40 includes an auxiliary block 41, a guide roller 42, a fixing bolt 43, a bushing 44, a bearing 45, a rotation ring 46, and a fastening means 47.

The auxiliary block 41 is position-adjustably fixed to an upper surface of the guide block 14 of the main body 10. A slotted hole 41b is formed at an upper surface of the auxiliary block 41 in a longitudinal direction to adjust a position of the auxiliary block 41 to fix it to the main body 10. In addition, a coupling hole 41a is formed at a front end of the auxiliary block 41 to install the guide roller 42.

The guide roller 42 having a through-hole 42a at its center is coupled to be rotated about the fixing bolt 43 coupled to the coupling hole 41a formed at the front end of the auxiliary block 41.

The fixing bolt 43, a coupling member for rotatably coupling the guide roller 42 to the auxiliary block 41, is inserted into the through-hole 42a of the guide roller 42 to be coupled to the coupling hole 41a of the auxiliary block 41. The bushing 44 is inserted into the through-hole 42a of the guide roller 42 to maintain smooth rotation of the pressing roller 22. The bearing 45 is press-fitted between the inner circumference of the guide roller 42 and the outer circumference of the bushing 44 to reduce friction between the guide roller 42 and the bushing 44, allowing smooth rotation of the guide roller 42.

The rotation ring 46 is coupled to an upper end of the fixing bolt 43 and installed between the auxiliary block 41 and the guide roller 42 to reduce friction between the auxiliary block 41 and the guide roller 42. The fastening means 47, a fastener such as a screw or a bolt, etc., for adjusting a position of the auxiliary block 41 to fix it to the guide block 14, is press-fitted into the slotted hole 41b of the auxiliary block 41 to be coupled to the coupling hole 14b of the guide block 14.

Hereinafter, an operation of the apparatus for inserting a seal into a slewing bearing of this embodiment will be described in detail with reference to FIGS. 5 to 7.

As shown in FIGS. 5 and 6, in the apparatus for inserting a seal into a slewing bearing of this embodiment, the knob of the adjustment unit 30 is rotated to adjust a position of the pressing unit 20, and adjust an insertion position of the seal 130 to the sealing installation position of the first ring 110 of the slewing bearing.

That is, since the threaded part 33c of the adjuster 33 is threadedly engaged with an adjustment hole 21d formed at a rear surface of the pressing block 21, the knob 33a of the adjuster 33 is operated to move the pressing block 21 forward and backward using rotation of the threaded part 33c, adjusting a position of the pressing unit 20.

In addition, the pressing unit 20 can be previously guided by the guide unit 40 installed at a lateral side of the pressing unit 20 to a predetermined distance before the seal 130 is installed at the sealing installation position of the slewing bearing. Therefore, the guide roller 42 of the guide unit 40 may project backward from a position, at which the pressing roller 22 of the pressing unit 20 projects, by a predetermined distance d.

As shown in FIGS. 5 and 7, the apparatus for inserting a seal into a slewing bearing of this embodiment is fixedly installed in the coupling hole formed in the second ring 120 of the slewing bearing through the fasteners 50 such as bolts and nuts, etc.

Further, in this state, the pressing unit 20 of this embodiment is installed to project toward the sealing installation position of the first ring 110, and the guide unit 40 is installed to guide the seal 130 thereto.

That is, when the second ring 120 is fixed and the first ring 110 is rotated in a state in which the pressing roller 22 and the guide roller 42 project toward the sealing installation position of the slewing bearing, the guide roller 42 and the pressing roller 22 sequentially contact the seal 130 and are rotated to gradually insert the seal 130 into the sealing installation position of the first ring 110.

This embodiment described that the insertion apparatus is installed at the second ring 120 of the slewing bearing to press the seal 130 against outer surfaces of the pressing roller 22 and the guide roller 42.

Of course, on the other hand, the seal insertion apparatus of this embodiment may also be installed at the first ring 110 of the slewing bearing to guide and press the seal 130 against inner surfaces of the pressing roller 22 and the guide roller 42.

That is, when the seal insertion apparatus of this embodiment is installed at the first ring 110, it is also possible that the first ring 110 of the slewing bearing is fixed and the second ring 120 is rotated about the first ring 110 to install the seal 130 at the sealing installation position.

As described above, in the seal insertion apparatus of the slewing bearing of this embodiment, any one of the first ring 110 and the second ring 120 of the slewing bearing may be fixed, and the other may be rotated to install the seal 130 at the sealing installation position of the slewing bearing.

In addition, while the guide unit 40 of this embodiment is installed at one side end of the main body 10, the guide unit 40 may be installed at both side ends of the main body 10 to be applied even when a rotational direction of the first ring 110 or the second ring of the slewing bearing is opposite.

Therefore, the seal insertion apparatus in this embodiment can solve a problem that the first ring 110 and the second ring must be separated or the fixing part and the rotation part installed therein must be completely separated during a seal exchange or repair operation of the slewing bearing.

As apparent from the above description, the main body is fixed to the first ring or the second ring of the slewing bearing, and the seal is installed at the sealing installation position by relative rotation between the rings, so that the seal of the slewing bearing can be easily exchanged and an exchange operation time can be reduced.

In addition, the slewing bearing can be repaired and a repair operation time can be reduced, without separation of the first ring and the second ring of the slewing bearing and without separation of the fixing part and the rotation part installed thereto, during a repair operation of the slewing bearing.

Further, the adjustment unit is installed at the pressing unit so that the apparatus can be applied to various sizes of slewing bearings and various sizes of seals.

The guide unit is installed adjacent to the pressing unit so that the seal can be easily guided to the pressing unit before the seal is pressed to the sealing installation position of the slewing bearing.

The roller is installed at the pressing unit and the guide unit to reduce a contact resistance with the seal to allow easy pressing guidance of the seal.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

What is claimed is:

1. An apparatus for inserting a seal into a slewing bearing comprising:
a main body fixed to any one of a first ring and a second ring of the slewing bearing; and
a pressing unit projecting from an upper part of the main body toward one side to protrude toward a sealing installation position provided at the other one of the first ring and the second ring, at which the main body is not installed,
wherein the pressing unit is installed by pressing a seal supplied from the exterior to the sealing installation position toward the sealing installation position as the first ring and the second ring are relatively rotated to each other.

2. The apparatus according to claim 1, wherein the main body has a fixing groove to be fixed to any one of the first ring and the second ring by a fastener.

3. The apparatus according to claim 1, wherein the pressing unit comprises a is pressing roller for pressing a seal to the sealing installation position.

4. The apparatus according to claim 1, wherein the main body has a sliding groove in which the pressing unit slides to approach or be spaced apart from the sealing installation position, and
further comprising an adjustment unit for adjusting a sliding position of the pressing unit in the sliding groove.

5. The apparatus according to claim 4, wherein the adjustment unit comprises an adjuster threadedly engaged with the pressing unit to slide the pressing unit through a rotation operation.

6. The apparatus according to claim 4, wherein the main body comprises a measurement means for measuring a sliding position of the pressing unit in the sliding groove of the pressing unit.

7. The apparatus according to claim 1, further comprising a guide unit disposed on the main body and adjacent to the pressing unit to guide the seal supplied from the exterior toward the pressing unit.

8. The apparatus according to claim 7, wherein the guide unit comprises a guide roller.

9. The apparatus according to claim 7, wherein the guide unit is position-adjustably fixed on the main body.

10. The apparatus according to claim 9, wherein the guide unit has a slotted hole for adjusting a position thereof on the main body, and is fixed on the main body through a fastening means inserted into the slotted hole.
